(19) United States
(12) Patent Application Publication
(10) Pub. No.: US 2017/0211629 A1
(43) Pub. Date: Jul. 27, 2017

(54) SEGMENTED CAGE AND USE THEREOF

(71) Applicant: Aktiebolaget SKF, Goteborg (SE)

(72) Inventors: Hongyuan An, Shanghai (CN); Ajay S Wadhwa, Wayne, PA (US)

(21) Appl. No.: 15/326,888

(22) PCT Filed: Jul. 8, 2015
(86) PCT No.: PCT/CN2015/083565

§ 371 Date: Jan. 17, 2017

(30) Foreign Application Priority Data
Jul. 21, 2014 (CN) 201410345857.7

(51) Int. Cl. F16C 33/66

(52) U.S. Cl. CPC F16C 33/6681

(57) ABSTRACT

A segmented cage for a ball bearing is provided, having multiple independent spacers, distributed at intervals between rolling elements of equal number to the spacers. A pocket slot is formed on each of two sides of each spacer in a position of contact with the rolling element, a concave curved surface adapted to hold the rolling element is formed in the pocket slot, and opposing pocket slots of adjacent spacers are matched to form a cage pocket for enveloping the rolling element. At least one main oil hole is formed in each spacer, running through the interior of the spacer and opening at the pocket slots on the two sides. The rolling element is held by the concave curved surface such that the rolling element is unable to contact with an opening edge, in the pocket slot, of the at least one pair of main oil holes.

### FIELD OF THE INVENTION

The present invention relates to a segmented cage, and a ball bearing using the segmented cage.

### BACKGROUND OF THE INVENTION

The number of rolling elements of a ball bearing using a one-piece cage is limited by the bar width of the cage (width of cage bar) in the circumferential direction, and so the load carrying capability thereof is correspondingly limited. A segmented cage allows a smaller circumferential separation to be employed between rolling elements, and therefore allows a greater number of rolling elements to be packed into a bearing of the same size. Such a cage can significantly increase the load carrying capability of the bearing, and has broad application prospects especially under conditions of high load at low speed.

A segmented cage currently on the market, as shown in FIG. 1, is formed of multiple independent spacers 1, which are distributed at intervals between an equal number of rolling elements 2. Pocket slots 3 are formed on two sides (in the circumferential direction of the bearing) of each spacer 1, in positions of contact with the rolling elements 2, and a cage pocket for enveloping a rolling element 2 is formed in a matching manner between adjacent pocket slots 3. For the purpose of lubrication, a main oil hole 5 is also formed in each spacer 1 at the position of an axis N thereof, the main oil hole running through the interior of the spacer and opening at the pocket slots 3 on the two sides. The main oil hole 5 is used for circulating and storing lubricant. The structure described above can be shown more clearly in the enlarged sectional view of the spacer 1 shown in FIG. 2a.

FIG. 2b is a partial enlarged view of region A in FIG. 2a. As FIG. 2b shows, a concave curved surface 6 for holding a rolling element 2 is formed in the pocket slot 3. In the prior art, the concave curved surface 6 is actually a concave spherical surface of a size slightly larger than the rolling element 2. The purpose of using a concave spherical surface is to construct an ideal mode in which a “large sphere envelops a small sphere”, to try to realize optimum matching and guiding between the spacer 1 and the roller 2. However, as a consequence of the penetrating design of the main oil hole 5, the rolling element 2 can actually only come into contact with an opening edge 7 of the main oil hole 5 on the concave spherical surface 6. Such edge contact causes the contact stress between the rolling element 2 and the spacer 1 to be concentrated at the position of the opening edge 7 of the main oil hole 5, exacerbating wear between components, and not being conducive to the formation of a lubricating oil film between the rolling elements and the cage. Thus the mechanical efficiency and expected lifespan of the entire bearing is considerably reduced.

### BRIEF SUMMARY OF THE INVENTION

To avoid the numerous problems caused by the edge contact described above, the present invention provides a segmented cage, formed by multiple independent spacers. These independent spacers are distributed at intervals between rolling elements of equal number to the spacers. A pocket slot is formed on each of two sides of each spacer in a position of contact with the rolling element, a concave curved surface adapted to hold a rolling element is formed in the pocket slot, and a cage pocket for enveloping a rolling element is formed in a matching manner between adjacent pocket slots. At least one main oil hole is also formed in each spacer, running through the interior of the spacer and opening at the pocket slots on the two sides. The rolling element is held by the concave curved surface in such a way that the rolling element is unable to come into contact with an opening edge, in the pocket slot, of the main oil hole.

The segmented cage employing the structure described above can effectively avoid the problem of stress concentration caused by edge contact between the rolling element and the cage pocket (main oil hole), and can therefore effectively alleviate wear between components and the problem of premature failure of the bearing caused by such wear. From the perspective of lubrication, edge contact (sharp edge contact) itself implies lubricant starvation at the position of contact. Thus, if edge contact is avoided, this in itself implies improved lubrication and alleviation of wear.

On the basis of the segmented cage described above, the present invention further provides a ball bearing, in particular an angular contact ball bearing, a deep groove ball bearing and a four-point contact ball slewing bearing. Experiments have demonstrated that ball bearings employing the cage described above have a lower temperature rise, increased efficiency and an extended lifespan.

Various embodiments and beneficial technical effects of the present invention are described in detail below in conjunction with the accompanying drawings.

### BRIEF DESCRIPTION OF THE SEVERAL VIEWS OF THE DRAWING

FIG. 1 is a schematic sectional view of a ball bearing employing a segmented cage in the prior art.

FIG. 2a is a schematic sectional view of a spacer and rolling elements on two sides thereof in the prior art;

FIG. 2b is a partial enlarged view of region A in FIG. 2a;

FIG. 3a is a schematic sectional view of the spacer according to the present invention and rolling elements on two sides thereof.

FIG. 3b is a partial enlarged view of region A in FIG. 3a;

FIG. 4a is a schematic two-dimensional planar drawing of a planar circle and straight line used to form a spindle torus;

FIG. 4b is a three-dimensional schematic diagram of a spindle torus;

FIG. 5a is a schematic diagram of a three-dimensional model of the concave curved surface of the spacer of the present invention formed by a one-piece toroidal surface;

FIG. 5b is a schematic diagram of a three-dimensional model of the concave curved surface of the spacer of the present invention formed by joining together two partial toroidal surfaces;

FIG. 5c is a schematic sectional view of the mating between the concave curved surface of the spacer of the present invention and the rolling element;

FIG. 6a is a schematic sectional view of a concave curved surface formed independently by a paraboloidal surface, wherein a main oil hole is provided at the bottom of the paraboloidal surface, and the rolling element abuts the paraboloidal surface at a position other than the bottom thereof;

FIG. 6b is a schematic sectional view of a concave curved surface formed independently by an ellipsoid surface, wherein a main oil hole is provided at the bottom of the ellipsoid surface, and the rolling element abuts the ellipsoid surface at a position other than the bottom thereof;

FIG. 7a is a schematic sectional view of a concave curved surface formed independently by a paraboloidal surface, wherein the roller element abuts the bottom of the paraboloidal surface, with main oil holes being provided at positions on the paraboloidal surface other than the bottom thereof;

FIG. 7b is a schematic sectional view of a concave curved surface formed independently by an ellipsoid surface, wherein the roller element abuts the bottom of the ellipsoid surface, with main oil holes being provided at positions on the ellipsoid surface other than the bottom thereof;

FIG. 8a is a schematic view of the spacer, observed along the circumferential direction of the bearing;

FIG. 8b is a demonstrative diagram of lubricating grooves of different shapes;

FIG. 9a is a schematic sectional view of the spacer with an auxiliary oil hole provided in the interior thereof; and

FIG. 9b is a partial enlarged view of region A in FIG. 9a.

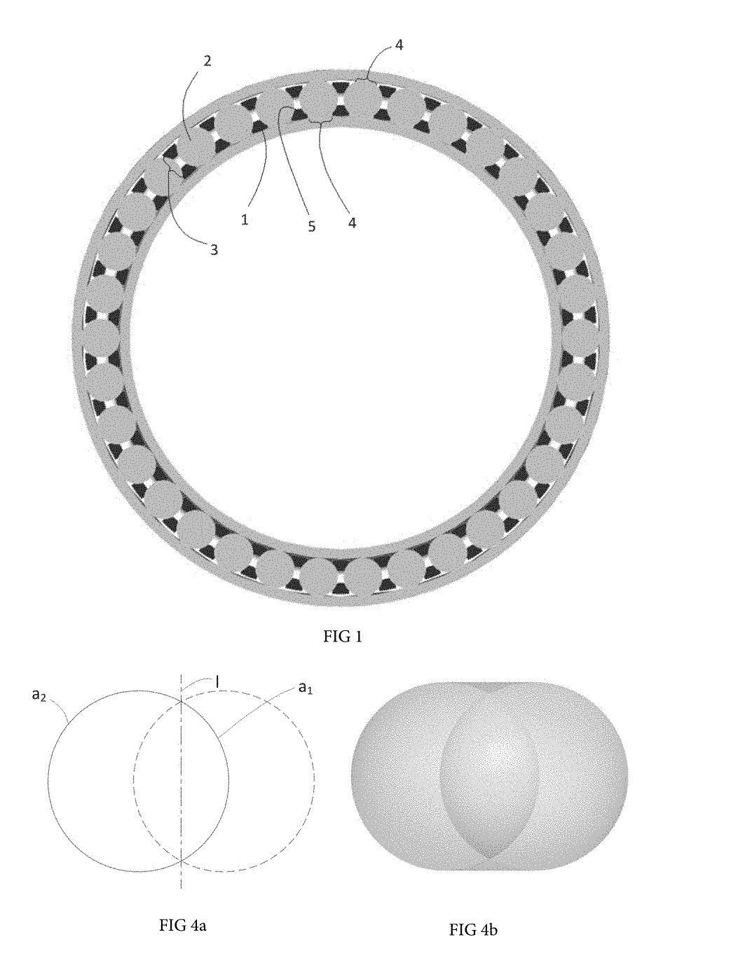

### DETAILED DESCRIPTION OF THE INVENTION

To prevent the rolling element 2 from touching the opening edge 7 (in the spacer pocket slot 3) of the main oil hole 5, the present invention, in terms of structure, principally employs the following two forms of implementation: 1. Similarly to the background art, the main oil hole 5 still opens at the deepest part of the concave shape of the pocket slot 3; however, the rolling element 2 only abuts a position on the concave curved surface 6 other than the deepest part of the concave shape (and hence cannot come into contact with the opening edge 7 of the main oil hole 5). 2. The concave curved surface 6 is formed to cover the deepest part of the concave shape of the pocket slot 3, and the rolling element 2 also actually abuts the deepest part of the concave shape; however, the main oil hole 5 opens at a position on the pocket slot 3 other than the deepest part of the concave shape thereof (and so the rolling element cannot come into contact with the opening edge of the main oil hole).

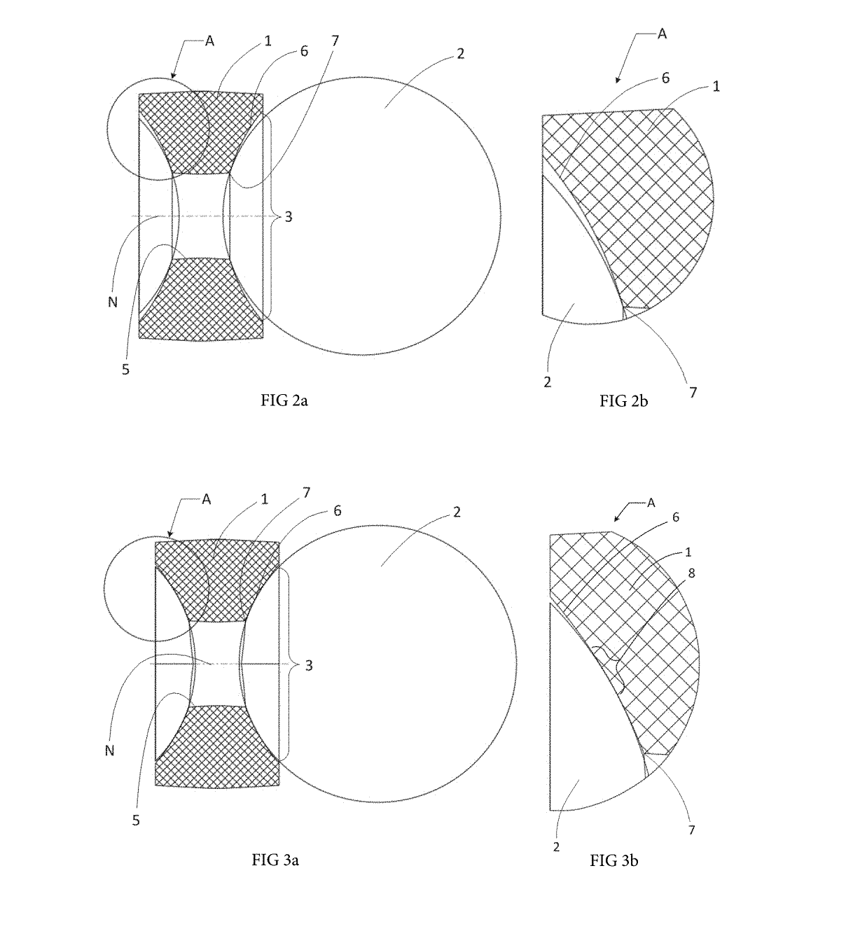

The first form of implementation mentioned above is described in detail below in conjunction with FIGS. 3a and 3b. FIG. 3a is a schematic sectional view of the spacer according to the present invention and spherical rollers on two sides thereof; FIG. 3b is a partial enlarged view of region A in FIG. 3a. Comparing FIGS. 2b and 3b, it can be seen that the position where the rolling element 2 abuts the concave curved surface 6 has been moved from the opening edge 7 of the main oil hole 5 shown in FIG. 2b to the “hinterland” of the concave curved surface 6 shown in FIG. 3b (i.e. an interior region other than the edge). Theoretically, as long as the rolling element 2 avoids the opening edge 7 of the main oil hole 5, any interior region is feasible. However, supposing that the rolling element 2 actually abuts the concave curved surface 6 at a position 8 roughly halfway along the slope length thereof, then this is after all a more optimal choice.

To achieve the abovementioned objective, the present invention first of all employs a technical solution in which the concave curved surface is formed by joining together two parts of a toroidal surface. The toroidal surface mentioned here is a geometric concept, meaning a curved surface in space obtained by rotating a circle through one revolution about a straight line lying in the same plane as the circle. Generally, such a toroidal surface is similar in shape to a doughnut or a lifebuoy. However, when the straight line is a chord on the circle, the toroidal surface obtained is a hole-less ring, commonly called a “spindle torus”. It earned this name because its shape is thick in the middle but thin at the two ends, like a spindle. As shown in FIGS. 4a and 4b, the spindle torus can be further subdivided into two types: one type is formed by rotating a short-section arc a1 of a length smaller than a semicircle about the straight line 1, and has a shape similar to a rugby ball; the other type is formed by rotating a long-section arc a2 of a length greater than a semicircle about the straight line 1, and has a shape similar to a pumpkin. When the straight line 1 passes through the centre of the circle, the toroidal surface will degenerate into a spherical surface. In this sense, a spherical surface is actually a special case of a toroidal surface. Incidentally, the circle mentioned here shall be defined herein as a “cross-sectional circle of the toroidal surface”.

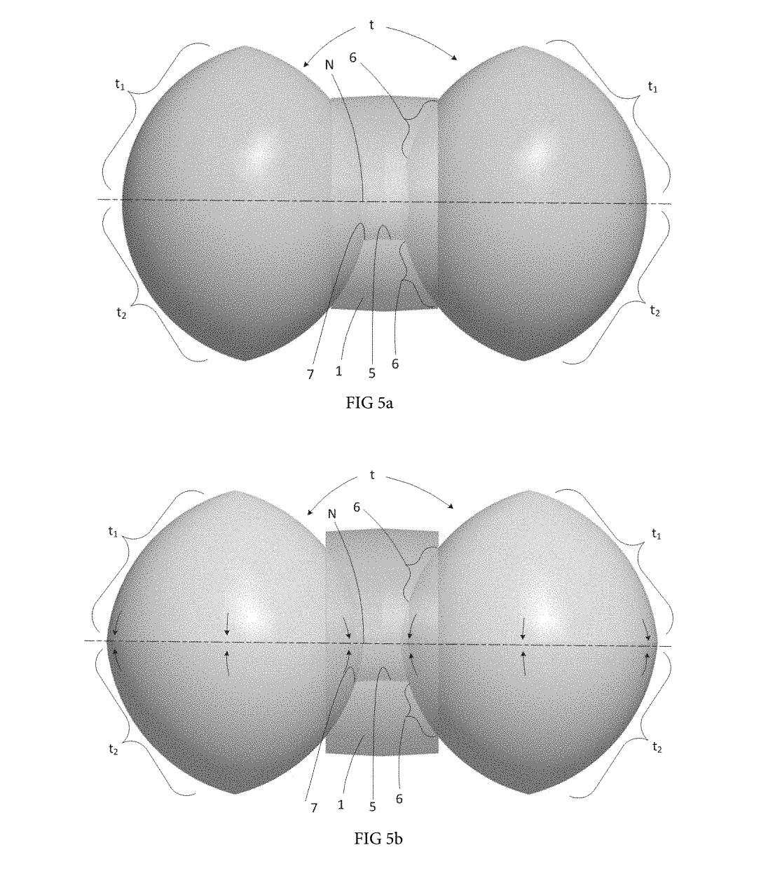

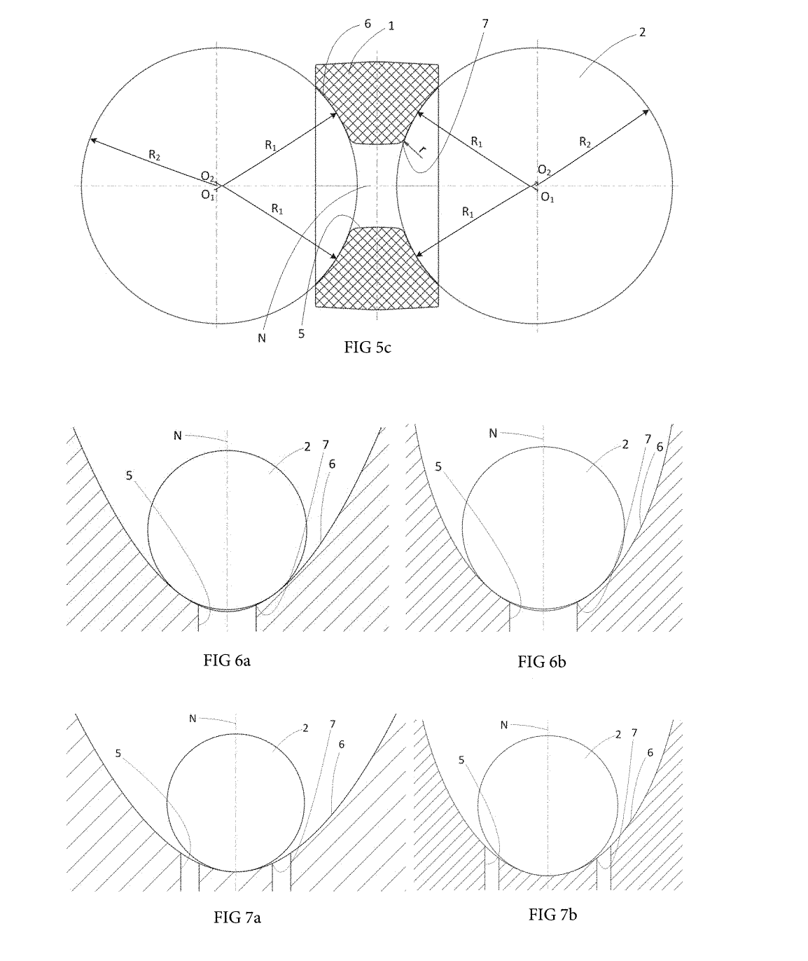

FIG. 5a is a schematic diagram of a three-dimensional model of the concave curved surface formed by a one-piece toroidal surface (one-piece torus). For the purpose of illustration, the toroidal surface shown in the figure is just one type of spindle torus, but the possibility of other types of toroidal surface being used as the concave curved surface is not excluded. It must be pointed out that FIG. 5a is intended to illustrate an intermediate state in the process of forming a particular technical solution in a first embodiment of the present invention; FIG. 5b shows the final state of the solution. Specifically, FIG. 5a shows that the concave curved surface 6 is formed independently by a one-piece toroidal surface t. To prevent the rolling element 2 from touching the opening edge 7 of the main oil hole 5 at the deepest part of the concave shape of the pocket slot 3, a partial toroidal surface t1 located above the axis N of the spacer 1 and a partial toroidal surface t2 located below the axis (shown in FIG. 5a) must furthermore be brought closer to each other by a suitable distance in directions pointing to each other (as shown by the arrows in FIG. 5b), in order to form the final technical solution shown in FIG. 5b.

Structural features of the abovementioned technical solution are expounded further below from a geometric perspective. FIG. 5c is a schematic sectional view of the mating between the concave curved surface and the rolling element in the technical solution. The concave curved surface 6 in the figure, as stated above, is formed by joining together two partial toroidal surfaces t1 and t2 which are distributed symmetrically around the axis N of the spacer 1. These two partial toroidal surfaces t1 and t2 have cross-sectional circle diameters that are equal to each other and both larger than the rolling element 2, and the circle centres O1 and O2 of the respective cross-sectional circles respectively cross over the axis N of the spacer 1, entering by a suitable distance the spatial ranges defined by the opposing-side partial toroidal surfaces t2 and t1, such that the position where the rolling element 2 abuts the concave curved surface 6 can be moved from the opening edge 7 of the main oil hole 5 to the interior region (hinterland) of the concave curved surface 6.

As stated above, a spherical surface is a special case of a toroidal surface. In this sense, the two partial toroidal surfaces t1 and t2 shown in FIGS. 5a-5c could actually also be two partial spherical surfaces (still referred to as t1 and t2 hereinbelow). In this case, the concave curved surface 6 is formed by joining together the two partial spherical surfaces t1 and t2 which are distributed symmetrically around the axis N of the spacer 1. These two partial spherical surfaces t1 and t2 have equal diameters which are both larger than the rolling element 2, and respective sphere centres O1 and O2 both cross over the spacer axis N, entering by a suitable distance the spatial ranges defined by the opposing-side partial spherical surfaces t2 and t1, such that the position where the rolling element 2 abuts the concave curved surface 6 can be moved from the opening edge 7 of the main oil hole 5 to the interior region (hinterland) of the concave curved surface 6.

What is described above is merely a particular technical solution in a first embodiment, i.e. a case where the concave curved surface is formed by joining together two partial toroidal surfaces or spherical surfaces with a symmetric structure. However, in order to move the position on the concave curved surface where the rolling element is supported from the bottom thereof to a position other than the bottom, the concave curved surface need not necessarily be formed by joining together two partial toroidal surfaces, but could also be formed independently by various types of one-piece curved surface. FIGS. 6a and 6b show schematic sectional views of concave curved surfaces formed independently by a paraboidal surface and an ellipsoid surface. As shown in the figures, the main oil hole 5 is provided at the bottom of these curved surfaces, and the rolling elements 2 abut positions on these curved surfaces other than the bottoms thereof. It can be easily understood that as long as the rolling element 2 avoids the opening edge 7 of the main oil hole 5 located at the deepest part of the pocket slot 3, e.g. two-point contact is maintained between the rolling element 2 and the concave curved surface 6 as shown in FIGS. 6a and 6b, then the object of the present invention can be achieved. In this sense, any other type of curved surface, e.g. a conical surface, hyperboloid surface or ovoid surface, can achieve the object of the present invention, as long as the way in which it holds the rolling element can prevent the rolling element from coming into contact with the opening edge of the main oil hole at the deepest part of the pocket slot.

In another technical solution in the first embodiment, to avoid direct contact between the rolling element and the opening edge of the main oil hole, the opening edge of the main oil hole may also undergo rounding, as shown in FIG. 5c, such that the rolling element can only come into contact with the interior region (hinterland) of the concave curved surface other than the opening edge of the main oil hole. This solution differs from the previous two technical solutions in that direct contact between the rolling element and the opening edge of the main oil hole can be effectively avoided not by remodelling the geometric shape of the concave curved surface, but by rounding the opening edge region of the main oil hole to a sufficient extent. This rounding to a sufficient extent can be expressed mathematically as r/R1≧5%, where r is the radius of curvature of the rounded main oil hole 5 on the edge 7 thereof, and R1 is the radius of curvature at the position of contact between the concave curved surface 6 and the rolling element 2. Technologically speaking, this method is simple, convenient and easy to execute; apart from rounding the edge of the oil hole, there is no need to improve the design of the concave spherical surface of the existing pocket slot in terms of shape. Thus, the solution has low costs, and gives an acceptable result.

A second embodiment of the present invention is expounded below. As stated above, the substance of the second embodiment lies in having the rolling element directly abut the deepest part of the concave shape of the pocket slot (i.e. the bottom of the concave curved surface), and having the main oil hole open at another position in the spacer slot. FIGS. 7a and 7b are schematic sectional views of the roller element 2 directly abutting the bottom of a paraboloidal surface 6 or ellipsoid surface 6, with main oil holes 5 opening at positions on the concave curved surface 6 other than the bottom thereof. This embodiment does not impose excessive restrictions on the shape of the concave curved surface; a conventional concave curved surface, e.g. an annular surface, spherical surface, paraboloidal surface, ellipsoid surface or ovoid surface, can avoid contact between the rolling element and the opening edge of the main oil hole, as long as envelope contact (envelope curve contact) is possible between the bottom of the curved surface and the rolling element, and as long as the main oil hole opens at another position in the pocket slot.

Two embodiments of the present invention are described above. No matter which embodiment is implemented, the closer the radius of curvature of the concave curved surface, at the position of contact thereof with the spherical roller, is to the radius of the latter within a given range, the more conducive is the design to the elimination of stress concentration and incomplete lubrication. Taking a concave spherical surface (including the case of a combination of multiple partial spherical surfaces) as an example, when the ratio of the spherical surface radius R1 to the roller element radius R2 satisfies the relation 1.01≦R1/R2≦1.09, the data from a temperature rise experiment are lowest, indicating an optimal state of adaptation and an optimal state of lubrication between the spacer and the roller. The abovementioned dimensional relation is similarly important for other types of concave curved surface. That is, when the ratio of the radius of curvature of the concave curved surface, at the position of contact thereof with the rolling element, to the radius of the rolling element is in the range of 101%-109%, the state of adaptation between the spacer and the roller is optimal.

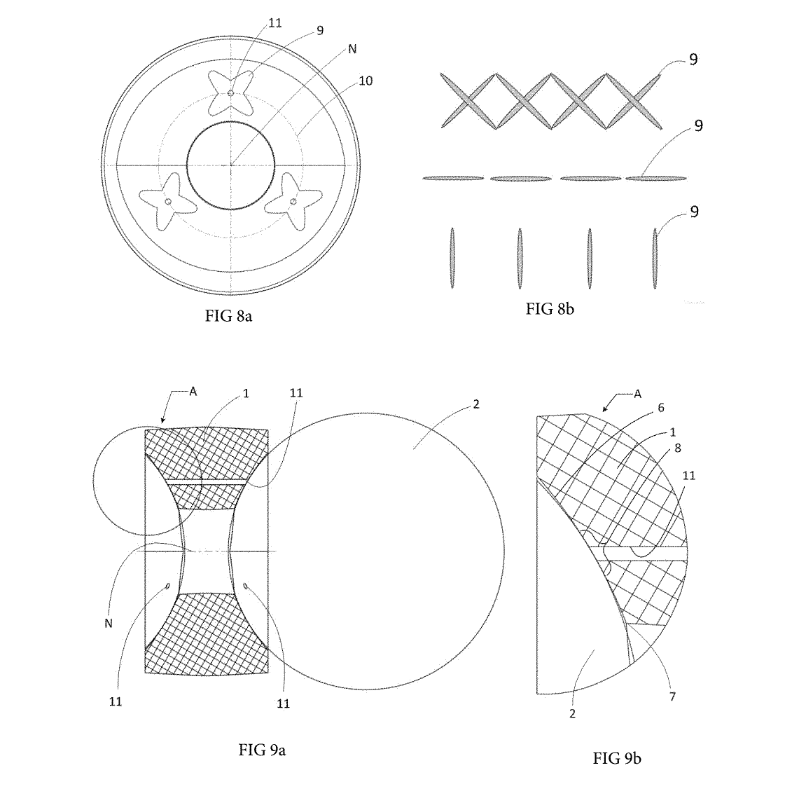

To further improve lubrication, a lubricating groove may be added at the position of contact between the concave curved surface and the rolling element. FIG. 8a is a front view of the spacer, observed along the circumference of the bearing. It can be seen from the figure that three petal-shaped lubricating grooves 9 are distributed on the concave curved surface 6 at equal intervals around the axis N of the spacer 1; the centres of the lubricating grooves 9 are distributed on a position line 10 of contact between the concave curved surface 6 and the rolling element 2. The position line 10 corresponds to the previously mentioned position 8 halfway along the slope length of the concave curved surface 6 (see FIG. 3b). Of course, the position line 10 could also be at another position along the slope length of the concave curved surface 6. The number of lubricating grooves 9 is also not limited to 3; 1-6 lubricating grooves could be provided appropriately depending on actual requirements. The shape of the lubricating grooves 9 could also be the strip shape or intersecting strip shape shown in FIG. 8b as required.

Another option is to provide an auxiliary oil hole 11 at the position of the lubricating groove 9, for the purpose of storing and circulating lubricant. FIG. 9a is a sectional view of a spacer in which an auxiliary oil hole is provided; FIG. 9b is a partial enlarged view of region A in FIG. 9a. It can be seen from the figures that the auxiliary oil hole 11 runs through the spacer 1, opening in the pocket slots 3 on two sides of the spacer 1. As a further option, the auxiliary oil hole 11 could also be provided at the bottom of the lubricating groove 9. As FIG. 8a shows, in this case the auxiliary oil hole 11 runs through the spacer 1, maintaining communication with the two lubricating grooves 9 at corresponding positions in the pocket slots 3 on two sides of the spacer.

On the basis of the structure described above, different materials may be used for the spacer 1. For instance, depending on the operating conditions and the load characteristics, the material used to manufacture the spacer 1 could be carbon steel, steel alloys, copper alloys, aluminium alloys, sintered materials, composite materials, engineering plastics or polymers.

The segmented cage described above may be widely used in ball bearings of various types, in particular angular contact ball bearings, deep groove ball bearings and four-point contact ball slewing bearings, etc.

Those skilled in the art will understand that various forms of changes and improvements in connection with the cage and the use thereof shall fall within the scope of protection of the present invention, as long as they comply with the definitions of the attached claims.

1. A segmented cage for a ball bearing, comprising: multiple independent spacers, distributed at intervals between rolling elements of equal number to the spacers, wherein
a pocket slot is formed on each of two sides of each spacer in a position of contact with the rolling element, a concave curved surface adapted to hold the rolling element is formed in the pocket slot, and opposing pocket slots of adjacent spacers are matched to form a cage pocket for enveloping the rolling element; and
at least one main oil hole is formed in each spacer, running through the interior of the spacer and opening at the pocket slots on the two sides; wherein
the rolling element is held by the concave curved surface in such a way that the rolling element is unable to come into contact with an opening edge, in the pocket slot, of the at least one main oil hole.

2. The segmented cage according to claim 1, wherein the at least one main oil hole opens at the deepest part of the concave shape of the pocket slot, and the rolling element abuts an interior region of the concave curved surface other than the deepest part of the concave shape of the pocket slot.

3. The segmented cage according to claim 2, wherein
the concave curved surface is formed by joining together two partial toroidal surfaces (t1 and t2) that are distributed symmetrically around an axis (N) of the spacer, the two partial toroidal surfaces (t1 and t2) having cross-sectional circle diameters that are equal to each other and both larger than the rolling element; and wherein
cross-sectional circle centers (O1 and O2) of the two partial toroidal surfaces (t1 and t2) respectively cross over the axis (N) of the spacer, entering by spatial ranges defined by the opposing-side partial toroidal surfaces (t2 and t1).

4. The segmented cage according to claim 3, wherein the two partial toroidal surfaces (t1 and t2) are actually two partial spherical surfaces (t1 and t2) having diameters that are equal to each other and both larger than the rolling element, and sphere centers (O1 and O2) of the two partial spherical surfaces respectively cross over the axis (N) of the spacer, entering by spatial ranges defined by the opposing-side partial spherical surfaces (t2 and t1).

5. The segmented cage according to claim 2, wherein the concave curved surface is formed independently by at least one of a one-piece paraboloidal surface, one-piece ellipsoid surface and one-piece ovoid surface.

6. The segmented cage according to claim 2, wherein the opening edge of the at least one main oil hole undergoes rounding, such that the rolling element can only come into contact with an interior region of the concave curved surface other than the opening edge of the main oil hole.

7. The segmented cage according to claim 6, wherein the radius of curvature at the position of the opening edge after rounding thereof is r, and the ratio thereof to the radius of curvature R1 at the position of contact between the concave curved surface and the rolling element, r/R1, is not less than 5%.

8. The segmented cage according to claim 1, wherein the concave curved surface is formed to cover the deepest part of the concave shape of the pocket slot, the rolling element abuts the bottom of the concave curved surface, and the at least one main oil hole opens at a position in the pocket slot other than the deepest part of the concave shape thereof.

9. The segmented cage according to claim 8, wherein the concave curved surface is formed independently by at least one of a one-piece annular surface, one-piece spherical surface, one-piece paraboloidal surface, one-piece ellipsoid surface and one-piece ovoid surface.

10. The segmented cage according to claim 2, wherein the rolling element abuts the concave curved surface at a position roughly halfway along the slope length thereof.

11. The segmented cage according to claim 1, wherein the ratio of the radius of curvature R1 of the concave curved surface, at the position of contact thereof with the rolling element, to the radius R2 of the rolling element satisfies the relation 1.01≦R1/R2≦1.09.

12. The segmented cage according to claim 1, further comprises a lubricating groove that is formed on the concave curved surface at the position of contact thereof with the rolling element.

13. The segmented cage according to claim 12, at least one of lubricating grooves is/are provided in the pocket slot on one side of the spacer, and are distributed uniformly on a position line of contact between the concave curved surface and the rolling element.

14. The segmented cage according to claim 13, wherein the shape of the lubricating groove is a petal shape, strip shape or intersecting strip shape.

15. The segmented cage according to claim 12, further comprises an auxiliary oil hole running through the spacer is formed at the bottom of the lubricating groove, and maintains communication with a lubricating groove at a corresponding position in the pocket slot on the other side of the spacer.

16. The segmented cage according to claim 1, further comprises at least one auxiliary oil hole is formed in the spacer, running through the interior thereof, the auxiliary oil holes opening in the pocket slots on the two sides.

17. The segmented cage according to claim 1, wherein the material used to manufacture the spacer is at least one of carbon steel, steel alloys, copper alloys, aluminum alloys, sintered materials, composite materials, engineering plastics and polymers.

18. A ball bearing, comprising:
a segmented cage having multiple independent spacers, distributed at intervals between rolling elements of equal number to the spacers, wherein
a pocket slot is formed on each of two sides of each spacer in a position of contact with the rolling element, a concave curved surface adapted to hold the rolling element is formed in the pocket slot, and opposing pocket slots of adjacent spacers are matched to form a cage pocket for enveloping the rolling element; and
at least one main oil hole is formed in each spacer, running through the interior of the spacer and opening at the pocket slots on the two sides; wherein
the rolling element is held by the concave curved surface in such a way that the rolling element is unable to come into contact with an opening edge, in the pocket slot, of the at least one main oil hole.

19. The ball bearing according to claim 18, wherein the ball bearing is at least one of an angular contact ball bearing, deep groove ball bearing and four-point contact ball slewing bearing.
